(19) United States
(12) Patent Application Publication
(10) Pub. No.: US 2026/0349916 A1
(43) Pub. Date: Nov. 5, 2026

(54) Data Storage Device and Method for Validity Bitmap Preparation with Dynamic Zone Identification for Relocation

(71) Applicant: Sandisk Technologies, Inc., Milpitas, CA (US)

(72) Inventors: Alston Neil Gama, Bengaluru (IN); Govind Kumar Mangal, Bengaluru (IN)

(73) Assignee: Sandisk Technologies, Inc., Milpitas, CA (US)

(21) Appl. No.: 19/198,345

(22) Filed: May 5, 2025

(51) Int. Cl. G06F 12/02; G06F 12/0817

(52) U.S. Cl. CPC G06F 12/0246; G06F 12/0817; G06F 2212/7201

(57) ABSTRACT

A block of memory of a data storage device can be organized into a plurality of zones. In creating a validity bitmap for a garbage collection operation, a data validity scan can be performed sequentially starting from the first zone of the block to the last zone of the block. Thus, the number of data validity scans equals the number of zones in the block. However, if valid locations are found only in later zones, the data validity scans performed in earlier zones were unnecessary. To avoid this problem, the embodiments presented herein describe a way to create a validity bitmap for a block where the number of data validity scans used to create the validity bitmap is less than a number of zones in the block.

### BACKGROUND

Some data storage devices create a validity bitmap to identify valid locations in a block for use in a relocation/garbage collection operation. Data storage devices with relatively large block sizes can organize a block into a plurality of zones, where the data validity scan is performed sequentially starting from the first zone in the block to the last zone in the block. In this method of creating a validity bitmap, the number of data validity scans equals the number of zones in the block.

### BRIEF DESCRIPTION OF THE DRAWINGS

FIG. 1A is a block diagram of a data storage device of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the data storage device illustrated in FIG. 1A according to an embodiment.

FIG. 2B is a block diagram illustrating components of the data storage device illustrated in FIG. 1A according to an embodiment.

FIG. 3 is a block diagram of a host and a data storage device of an embodiment.

FIG. 4 is a block representation of an embodiment showing location validity.

FIG. 5 is a validity bitmap representation of an embodiment.

FIG. 6 is a block representation of an embodiment showing location validity in a last zone of a block.

FIG. 7 is a diagram illustrating validity bitmap preparation to highlight an advantage of an embodiment.

FIG. 8 is a flow chart of a method of an embodiment for creating a validity bitmap.

FIG. 9 is a representation of directories of logical-to-physical address translation tables of an embodiment.

### DETAILED DESCRIPTION

The following embodiments generally relate to a data storage device and method for validity bitmap preparation with dynamic zone identification for relocation. In one embodiment, a data storage device is provided comprising a memory and one or more processors. The memory comprises a plurality of blocks, wherein each block is organized into a plurality of zones. The one or more processors, individually or in combination, are configured to: read a plurality of logical-to-physical address translation tables from the memory; create a validity bitmap for a block in the memory by analyzing each of the plurality of logical-to-physical address translation tables to identify location(s) in the zones in the block that store valid data, wherein a number of iterations of analyzing each of the plurality of logical-to-physical address translation tables to create the validity bitmap is less than a number of zones in the plurality of zones; and use the validity bitmap to relocate the valid data.

In another embodiment, a method is provided that is performed in a data storage device with a memory comprising a block organized into a plurality of zones, each zone having a maximum number of locations. The method comprises: (a) determining whether an entry in a first directory of a plurality of directories of logical-to-physical address translation tables belongs to the block; (b) in response to determining that the entry belongs to the block, setting a selected zone as an entry location divided by the maximum number of locations and setting a corresponding bit in a validity bitmap; (c) repeating (a)-(b) for additional entries in the first directory of the plurality of directories of logical-to-physical address translation tables; and (d) using the validity bitmap in a garbage collection operation.

In yet another embodiment, a data storage device is provided comprising: a memory comprising a block organized into a plurality of zones; and means for creating a validity bitmap for the block by analyzing a plurality of logical-to-physical address translation tables, wherein a number of times that the plurality of logical-to-physical address translation tables is analyzed to create the validity bitmap is less than a number of zones in the plurality of zones.

Other embodiments are possible, and each of the embodiments can be used alone or together in combination. Accordingly, various embodiments will now be described with reference to the attached drawings.

### Embodiments

The following embodiments relate to a data storage device (DSD). As used herein, a “data storage device” refers to a non-volatile device that stores data. Examples of DSDs include, but are not limited to, hard disk drives (HDDs), solid state drives (SSDs), tape drives, hybrid drives, etc. Details of example DSDs are provided below.

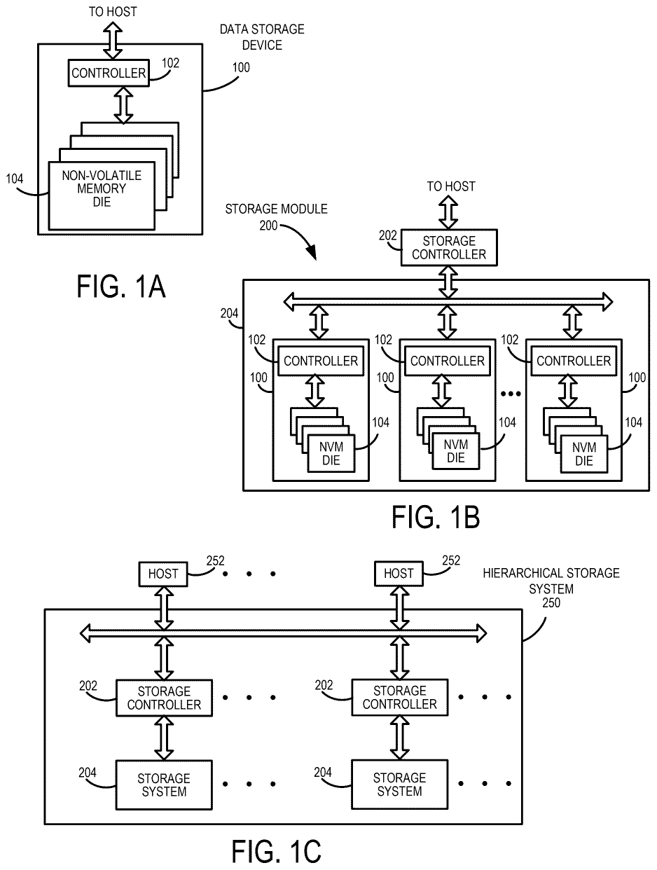

Examples of data storage devices suitable for use in implementing aspects of these embodiments are shown in FIGS. 1A-1C. It should be noted that these are merely examples and that other implementations can be used. FIG. 1A is a block diagram illustrating the data storage device 100 according to an embodiment. Referring to FIG. 1A, the data storage device 100 in this example includes a controller 102 coupled with a non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. The controller 102 interfaces with a host system and transmits command sequences for read, program, and erase operations to non-volatile memory die 104. Also, as used herein, the phrase “in communication with” or “coupled with” could mean directly in communication/coupled with or indirectly in communication/coupled with through one or more components, which may or may not be shown or described herein. The communication/coupling can be wired or wireless.

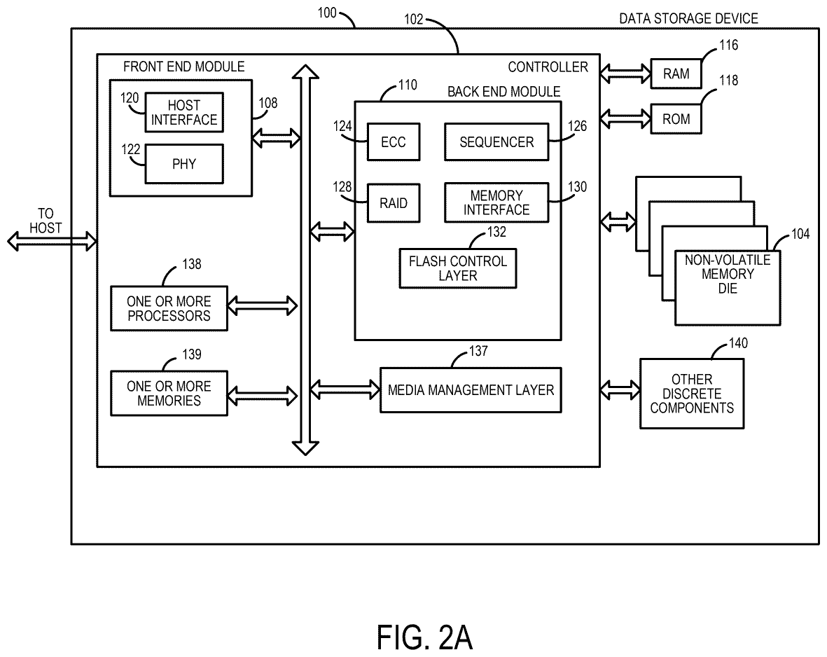

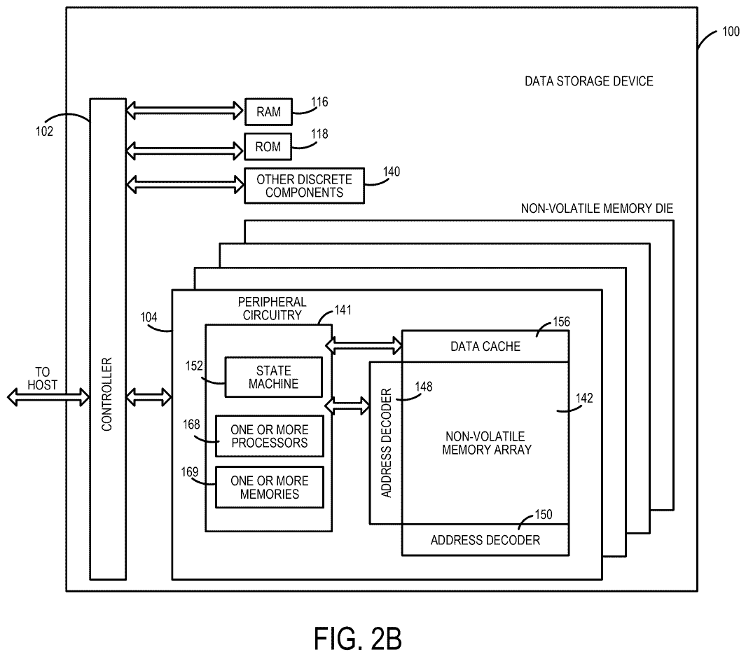

The controller 102 (which may be a non-volatile memory controller (e.g., a flash, resistive random-access memory (ReRAM), phase-change memory (PCM), or magnetoresistive random-access memory (MRAM) controller)) can include one or more components, individually or in combination, configured to perform certain functions, including, but not limited to, the functions described herein and illustrated in the flow charts. For example, as shown in FIG. 2A, the controller 102 can comprise one or more processors 138 that are, individually or in combination, configured to perform functions, such as, but not limited to the functions described herein and illustrated in the flow charts, by executing computer-readable program code stored in one or more non-transitory memories 139 inside the controller 102 and/or outside the controller 102 (e.g., in random access memory (RAM) 116 or read-only memory (ROM) 118). As another example, the one or more components can include circuitry, such as, but not limited to, logic gates, switches, an application specific integrated circuit (ASIC), a programmable logic controller, and an embedded microcontroller.

In one example embodiment, the non-volatile memory controller 102 is a device that manages data stored on non-volatile memory and communicates with a host, such as a computer or electronic device, with any suitable operating system. The non-volatile memory controller 102 can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware (and/or other metadata used for housekeeping and tracking) to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC) (e.g., dual-level cells, triple-level cells (TLC), quad-level cells (QLC), etc.) or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, the data storage device 100 may be a card-based system, such as a secure digital (SD) or a micro secure digital (micro-SD) card. In an alternate embodiment, the data storage device 100 may be part of an embedded data storage device.

Although, in the example illustrated in FIG. 1A, the data storage device 100 (sometimes referred to herein as a storage module) includes a single channel between controller 102 and non-volatile memory die 104, the subject matter described herein is not limited to having a single memory channel. For example, in some architectures (such as the ones shown in FIGS. 1B and 1C), two, four, eight or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile data storage devices 100. As such, storage module 200 may include a storage controller 202 that interfaces with a host and with storage system 204, which includes a plurality of data storage devices 100. The interface between storage controller 202 and data storage devices 100 may be a bus interface, such as a serial advanced technology attachment (SATA), peripheral component interconnect express (PCIe) interface, double-data-rate (DDR) interface, or serial attached small scale compute interface (SAS/SCSI). Storage module 200, in one embodiment, may be a solid-state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system 250 via a bus interface. In one embodiment, the bus interface may be a Non-Volatile Memory Express (NVMe) or Fibre Channel over Ethernet (FCoE) interface. In one embodiment, the system illustrated in FIG. 1C may be a rack mountable mass storage system that is accessible by multiple host computers, such as would be found in a data center or other location where mass storage is needed.

Referring again to FIG. 2A, the controller 102 in this example also includes a front-end module 108 that interfaces with a host, a back-end module 110 that interfaces with the one or more non-volatile memory die 104, and various other components or modules, such as, but not limited to, a buffer manager/bus controller module that manage buffers in RAM 116 and controls the internal bus arbitration of controller 102. A module can include one or more processors or components, as discussed above. The ROM 118 can store system boot code. Although illustrated in FIG. 2A as located separately from the controller 102, in other embodiments one or both of the RAM 116 and ROM 118 may be located within the controller 102. In yet other embodiments, portions of RAM 116 and ROM 118 may be located both within the controller 102 and outside the controller 102.

Front-end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back-end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the non-volatile memory die 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. The controller 102 in this example also comprises a media management layer 137 and a flash control layer 132, which controls the overall operation of back-end module 110.

The data storage device 100 also includes other discrete components 140, such as external electrical interfaces, external RAM, resistors, capacitors, or other components that may interface with controller 102. In alternative embodiments, one or more of the physical layer interface 122, RAID module 128, media management layer 137 and buffer management/bus controller are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two-dimensional and/or three-dimensional configuration. Non-volatile memory die 104 further includes a data cache 156 that caches data and address decoders 148, 150. The peripheral circuitry 141 in this example includes a state machine 152 that provides status information to the controller 102. The peripheral circuitry 141 can also comprise one or more components that are, individually or in combination, configured to perform certain functions, including, but not limited to, the functions described herein and illustrated in the flow charts. For example, as shown in FIG. 2B, the non-volatile memory die 104 can comprise one or more processors 168 that are, individually or in combination, configured to execute computer-readable program code stored in one or more non-transitory memories 169, stored in the memory array 142, or stored outside the non-volatile memory die 104. As another example, the one or more components can include circuitry, such as, but not limited to, logic gates, switches, an application specific integrated circuit (ASIC), a programmable logic controller, and an embedded microcontroller.

In addition to or instead of the one or more processors 138 (or, more generally, components) in the controller 102 and the one or more processors 168 (or, more generally, components) in the non-volatile memory die 104, the data storage device 100 can comprise another set of one or more processors (or, more generally, components). In general, wherever they are located and however many there are, one or more processors (or, more generally, components) in the data storage device 100 can be, individually or in combination, configured to perform various functions, including, but not limited to, the functions described herein and illustrated in the flow charts. For example, the one or more processors (or components) can be in the controller 102, non-volatile memory die 104, and/or other location in the data storage device 100. Also, different functions can be performed using different processors (or components) or combinations of processors (or components). Further, means for performing a function can be implemented with a controller comprising one or more components (e.g., processors or the other components described above).

Returning again to FIG. 2A, the flash control layer 132 (which will be referred to herein as the flash translation layer (FTL) handles flash errors and interfaces with the host. In particular, the FTL, which may be an algorithm in firmware, is responsible for the internals of memory management and translates writes from the host into writes to the non-volatile memory die 104. The FTL may be needed because the non-volatile memory die 104 may have limited endurance, may be written in only multiples of pages, and/or may not be written unless it is erased as a block. The FTL understands these potential limitations of the non-volatile memory die 104, which may not be visible to the host. Accordingly, the FTL attempts to translate the writes from host into writes into the memory non-volatile memory die 104.

The FTL may include a logical-to-physical address (L2P) map (sometimes referred to herein as a table or data structure) and allotted cache memory. In this way, the FTL translates logical block addresses (“LBAs”) from the host to physical addresses in the non-volatile memory die 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

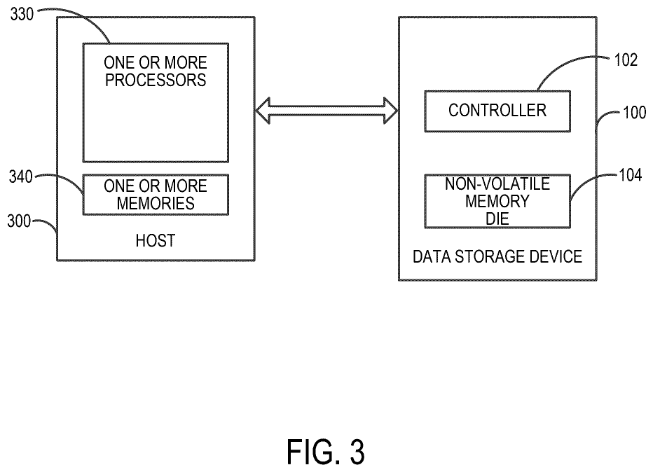

Turning again to the drawings, FIG. 3 is a block diagram of a host 300 and data storage device 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises one or more processors 330 and one or more memories 340. In one embodiment, computer-readable program code stored in the one or more memories 340 configures the one or more processors 330 to perform the acts described herein as being performed by the host 300. So, actions performed by the host 300 are sometimes referred to herein as being performed by an application (computer-readable program code) run on the host 300. For example, the host 300 can be configured to send data (e.g., initially stored in the host's memory 340) to the data storage device 100 for storage in the data storage device's non-volatile memory die 104.

As new data is written in the memory 104 and older data in the memory 104 is invalidated, the controller 102 in the data storage device 100 can perform a garbage collection operation to relocate valid data from one block to another block. In this way, the controller 102 can efficiently manage the available blocks in the memory 104. To relocate data from a source block to a destination block in the memory 104, the controller 102 first identifies the valid data in the source block. The controller 102 can use a validity bitmap for this purpose. For example, the validity bitmap can be created for each 4 KB data chunk, with a “1” bit set to indicate a memory location with valid data (a “valid location”), and a “0” bit set to indicate a memory location with invalid data (a “invalid location”). Of course, this is just an example, and other implementations can be used. For example, a 32 KB data chuck can be used for management data.

As NAND memory block size increases, more volatile memory (e.g., RAM) space may be needed during the relocation operation to store the validity bitmap of a full block. To address this, a block can be split into multiple zones, wherein the data validity scan is performed sequentially starting from the first zone (at the start of the block) to the last zone (at the end of the block). In operation, the controller 102 would read a plurality of logical-to-physical address translation tables from the memory 104. For each zone in the block starting from a first zone and moving sequentially to a last zone, the controller 102 can analyze the plurality of logical-to-physical address translation tables to identify location(s), if any, in the zone that store valid data. In this method, the number of iterations of analyzing the plurality of logical-to-physical address translation tables would always be equal to the number of zones in the block

If the valid locations are only in later zones (e.g., the last zone), the amount of work done in mapping the prior zones is of no use, resulting in unnecessary use of computation time, resources, and power. Additionally, extra handling may be required to remember the previously-working zone to handle a graceful or ungraceful shut-down case where work needs to be resumed after a controller reset/power down.

Consider, for example, a block (storing management data) having 10 zones, where the block has a few valid parts in the 9^{th} zone only. If the validity bitmap is prepared by selecting the first zone first, the method will not find any valid locations in the block to relocate until it reaches the 9^{th} zone. Thus, the controller 102 would have wasted a significant amount of time and resources to identify the valid locations, and those resources could have been used for other modules in the data storage device 100 for other, more meaningful operations.

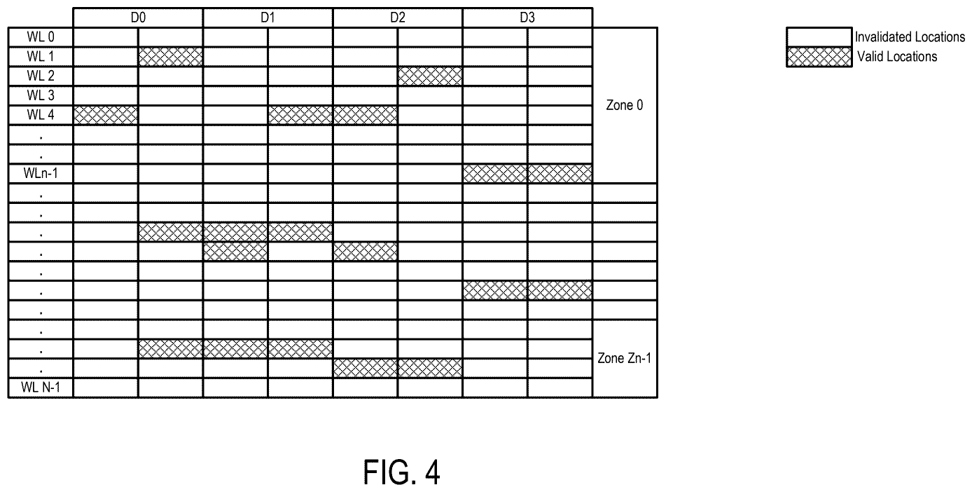

FIGS. 4-6 illustrate an example situation. In this example, the memory 104 is a BICS 8×4 1 Tb memory with 8 TB capacity, and the data storage device 100 is an enterprise solid state drive (eSSD), where ~17 kB is needed to hold the validity bitmap for the management block, and the block is split into multiple zones. To prepare the validity bitmap for a single zone, the controller 102 may need ~65 NAND (control data) read operations to load logical-to-physical address translation (L2P) directories (which indicate the locations of valid data) and ~130k data traversals of those directories to identify whether each entry in a directory is part of the given block and zone. This is a blocking mode operation in that any delays will impact foreground host write operations. In this example, control data, such as management tables/L2P tables, are stored randomly in the control block, and identification of valid L2P tables is done using directories. So, it is possible that the first valid data may belong to a later zone where initial zones have invalid data.

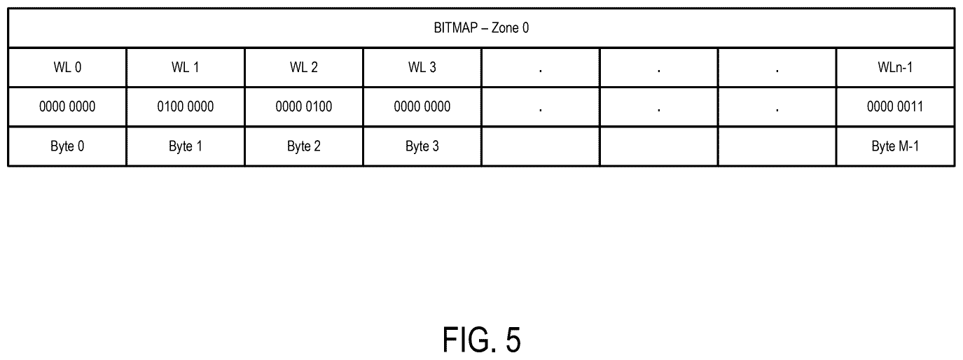

As mentioned above, in this example, validity bitmap preparation is done at the zone level and moves sequentially from the first zone to the last zone in a block. In the example shown in FIG. 4, a single block has four dies and “N” number of wordlines. This block is divided into “Zn” zones with each zone comprising of “WLn” wordlines. This block has some valid locations, and other locations with no valid locations (locations that are invalidated). FIG. 5 represents a validity bitmap for zone 0, where “M” bytes are needed to represent a bitmap per zone.

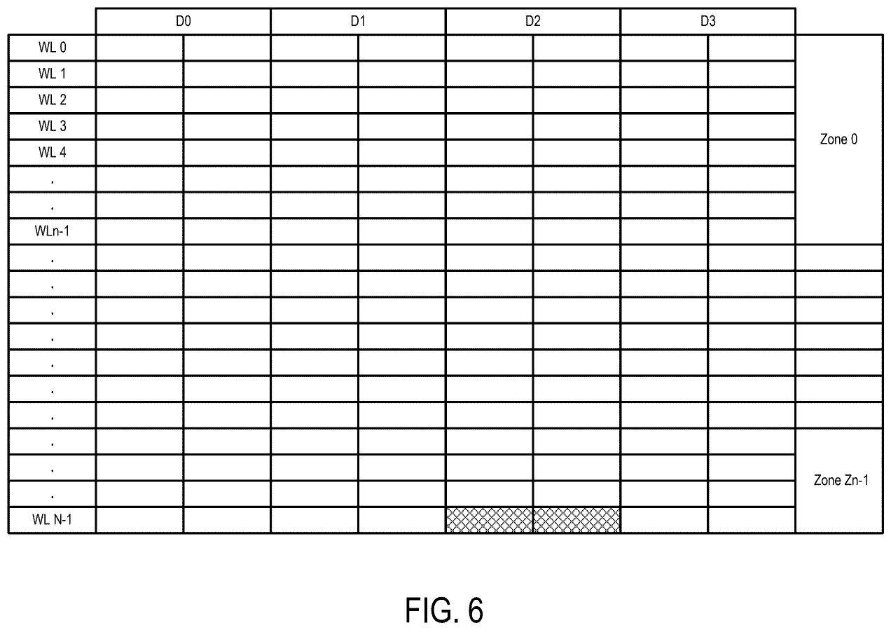

As illustrated in the example shown in FIG. 6, when the block has valid entries only in Zone Zn-1, the validity scans performed for Zone 0 to Zone Zn-2 were unneeded. In one embodiment, to avoid this situation, the controller 102 can still split the block into multiple zones for the bitmap preparation, but it will not select the starting zone as the first zone for traversing the data. That is, zone selection/traversal is not static. Instead, it is dynamic in nature, where during the data traversal, the bitmap preparation will be started based on the first-identified valid location. Wherever the first valid location is identified, that zone can be selected for eviction/relocation, and, once this is done, the same process can be followed until all valid locations from the block are relocated. At the end of each traversal, there would be some actionable outcome (e.g., the controller 102 can have some valid data to relocate from the identified zone).

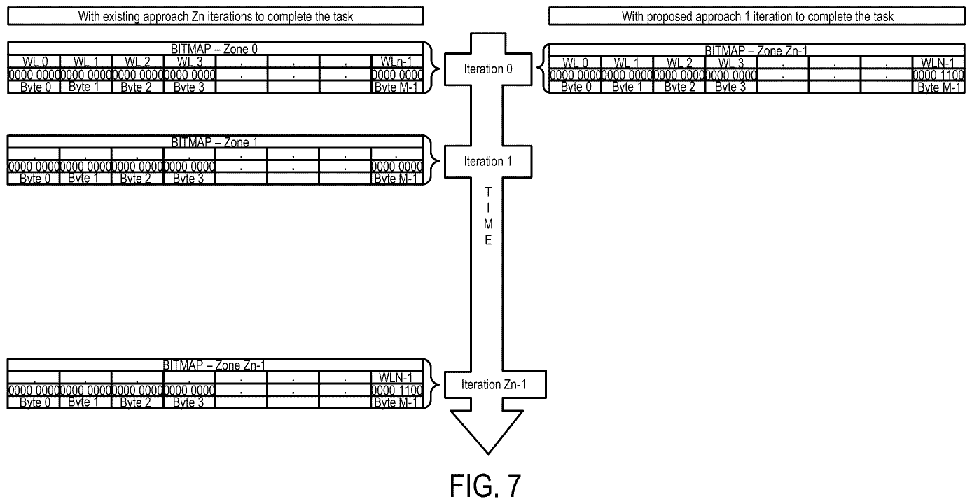

FIG. 7 illustrates an advantage of this embodiment, as applied to the example in FIG. 6. In this embodiment, zone selection occurs in a random order since the starting data may be in any zone. Hence, this solution may be more suitable where the data need not be in a sequential pattern (e.g., management data, random host data, etc.). In this embodiment, controller cycles of bitmap preparation will not be wasted, as there will be some valid zone to relocate, in contrast to the prior approach where firmware overheads would be repeated for each zone. As shown in FIG. 7, for a given block, it takes only a single iteration to complete the task, whereas the prior approach needs to complete one iteration per each zone. While a single iteration was used in this example, in other situations, more iterations are used but fewer than the number of zones. That is, a single scan can be used if validity is in a single zone. More generally, these embodiments can apply the necessary or minimally-required amount of scans.

Reducing the number of iterations performed can save time and resources. For example, consider a BICS 8×4 1 Tb memory with 8 TB capacity that has 8 zones per block. Each validity scan iteration can involve ~65 NAND (Control Data) reads for directories of each data size of 32 kB and ~130k data traversals. Thus, the average time required for one data scan iteration can be ~15 mSec. This can include time required to perform the above-mentioned operations along with firmware overhead. With the prior approach, the total time taken to build the validity bitmap for entire block=numZones*TimeTakenByOneIteration=8 Zones*15 mSec=~120 mSec. In contrast, with this embodiment, the total time taken to build the validity bitmap for the entire block=TimeTakenByOneIteration=~15 mSec. This is a significant gain in terms of performance/power and resources.

The following is an example algorithm that can be used by the controller 102 to implement this embodiment. It should be understood that this is merely an example and that other implementations can be used. In this example, consider a Block “B” to be relocated. Each zone maps to a maximum of “MAX_LOCATIONS_IN_ZONE” locations. The following steps can be performed to identify the zone for the current iteration and to prepare the bitmap:
(1) Start traversing from starting data and check if it is in Block “B.”
(2) If located in Block “B” at location “L,” set its corresponding “Zone” and set the respective bit in the bitmap area (e.g., Zone=L/MAX_LOCATIONS_IN_ ZONE).
(3) Goto next data and check if it is located in Block “B.”
(4) If it is located in Block “B” then, if “Zone” is already set from step (2), set the respective bit in the bitmap area; else, goto step (2) to set the “Zone” and bit.
(5) Repeat steps (3) and (4) until the last data is checked for its location.

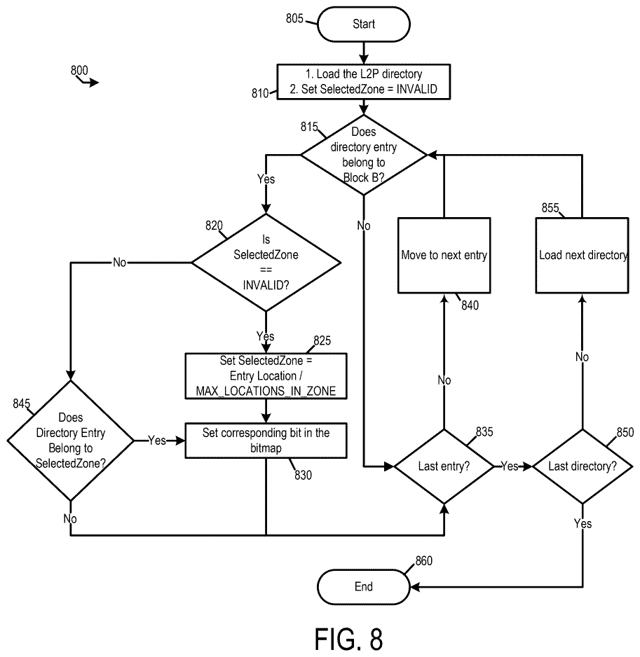

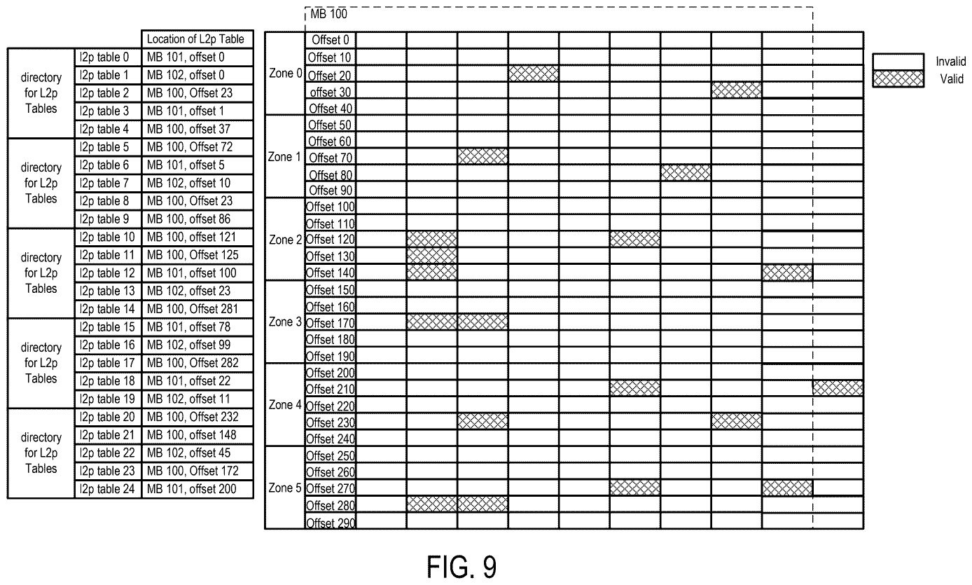

FIG. 8 is a flow chart 800 that illustrates an example method of an embodiment, and FIG. 9 is a representation of directories of logical-to-physical address translation tables that can be used in this example. As shown in FIG. 8, at the start (805) of the method, the controller 102 loads the L2P directory and sets the SelectedZone to be invalid (810). Next, the controller 102 determines if the directory entry belongs to Block B (815). If it does, the controller 102 determines if the SelectedZone is invalid (820). If the SelectedZone is invalid, the controller 102 sets the SelectedZone as the Entry Location/MAX_LOCATIONS_ IN_ZONE (825) and then sets the corresponding bit in the bitmap (830) (e.g., with reference to the example in FIG. 4: MAX_LOCATIONS_IN_ZONE=“WL n wordlines*4 dies*2 Locations per Die”). However, if the SelectedZone is not invalid, the controller 102 determines if the directory entry belongs to the SelectedZone (845). If it does, the method proceeds to 830, as described above. If it does not, the method proceeds to 835. The method also proceeds to 835 after the corresponding bit in the bitmap is set (830).

As 855, the controller 102 determines if it is at the last entry (835). If the controller 102 is not at the last entry, the controller 102 moves to the next entry (840), and the method loops back to 815. If the controller 102 is at the last entry, the controller 102 determines if it is at the last directory (850). If the controller 102 is not at the last directory, the controller 102 loads the next directory (855), and the method loops back to 815. If the controller 102 is at the last directory, the method ends (860), and the controller 102 can use the “SelectedZone” and “bitmap” to perform the relocation operation. While performing the relocation operation, the valid location in the block can be calculated as: (selectedZone*MAX_LOCATIONS_IN_ZONE)+(bit position in the bitmap).

There are several advantages associated with these embodiments. For example, these embodiments can avoid unwanted operations from relocation/garbage collection modules and, hence, efficiently utilize device resources, time, and power by the other modules. These embodiments can also improve overall write operation handling, which provides better host write profiling since write and relocation paths share the device computation time and resources. Further, these embodiments can improve overall drive performance by giving the device computation time and computation resources early for the host related operations. This may be especially advantageous for growing device capacities as garbage collection/relocation processes increase.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two-dimensional configuration, e.g., in an x-z plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three-dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A data storage device comprising:
a memory comprising a plurality of blocks, wherein each block is organized into a plurality of zones; and
one or more processors, individually or in combination, configured to:
read a plurality of logical-to-physical address translation tables from the memory;
create a validity bitmap for a block in the memory by analyzing each of the plurality of logical-to-physical address translation tables to identify location(s) in the zones in the block that store valid data, wherein a number of iterations of analyzing each of the plurality of logical-to-physical address translation tables to create the validity bitmap is less than a number of zones in the plurality of zones; and
use the validity bitmap to relocate the valid data.

2. The data storage device of claim 1, wherein the plurality of logical-to-physical address translation tables is analyzed sequentially.

3. The data storage device of claim 1, wherein the plurality of logical-to-physical address translation tables is stored in a plurality of directories.

4. The data storage device of claim 1, wherein creating the validity bitmap is dynamic in that a first location identified as storing valid data is not necessarily a first zone in the block.

5. The data storage device of claim 1, wherein the valid data comprises management data.

6. The data storage device of claim 1, wherein the valid data comprises random host data and/or sequential host data.

7. The data storage device of claim 1, wherein only the single iteration of analyzing the plurality of logical-to-physical address translation tables is performed if only one zone comprises valid data.

8. The data storage device of claim 1, wherein the block is formed from a plurality of memory dies and comprises a plurality of wordlines, and wherein the validity bitmap identifies valid locations in the plurality of wordlines.

9. The data storage device of claim 1, wherein the memory comprises a three-dimensional memory.

10. In a data storage device with a memory comprising a block organized into a plurality of zones, each zone having a maximum number of locations, a method comprising:
(a) determining whether an entry in a first directory of a plurality of directories of logical-to-physical address translation tables belongs to the block;
(b) in response to determining that the entry belongs to the block, setting a selected zone as an entry location divided by the maximum number of locations and setting a corresponding bit in a validity bitmap;
(c) repeating (a)-(b) for additional entries in the first directory of the plurality of directories of logical-to-physical address translation tables; and
(d) using the validity bitmap in a garbage collection operation.

11. The method of claim 10, further comprising repeating (a)-(c) for other directories in the plurality of directories of logical-to-physical address translation tables.

12. The method of claim 10, further comprising moving to a next entry or a next directory in response to determining that an entry does not belong to the block.

13. The method of claim 10, further comprising, in repeating (a)-(b):
determining whether an entry belongs to the selected zone;
setting a corresponding bit in the validity bitmap in response to determining that the entry belongs to the selected zone; and
moving to a next entry or a next directory in response to determining that the entry does not belong to the selected zone.

14. The method of claim 10, wherein a location in the block having valid data is calculated as the selected zone multiplied by the maximum number of locations plus a bit position in the validity bitmap.

15. The method of claim 10, wherein the validity bitmap is created dynamically in that a first location identified as storing valid data is not necessarily a first zone in the block.

16. The method of claim 10, wherein data in the block comprises management data.

17. The method of claim 10, wherein data in the block comprises random host data and/or sequential host data.

18. The method of claim 10, wherein a number of times that the plurality of logical-to-physical address translation tables is analyzed to create the validity bitmap is less than a number of zones in the plurality of zones.

19. The method of claim 10, wherein only the single iteration of analyzing the plurality of directories of logical-to-physical address translation tables is performed if only one zone comprises valid data.

20. A data storage device comprising:
a memory comprising a block organized into a plurality of zones; and
means for creating a validity bitmap for the block by analyzing a plurality of logical-to-physical address translation tables, wherein a number of times that the plurality of logical-to-physical address translation tables is analyzed to create the validity bitmap is less than a number of zones in the plurality of zones.
